(19) United States
(12) Patent Application Publication
(10) Pub. No.: US 2006/0117047 A1
(43) Pub. Date: Jun. 1, 2006

(54) Apparatus and method for presenting media content files

(75) Inventors: Jason William Flick, Ottawa (CA); Jean Paul Fauteux, Gatineau (CA)

Correspondence Address: KIRBY EADES GALE BAKER, BOX 3432, STATION D, OTTAWA, ON, K1P 6N9, CA

(73) Assignee: FLICK SOFTWARE INC.

(21) Appl. No.: 10/997,922

(22) Filed: Nov. 29, 2004

(51) Int. Cl. G06F 7/00

(52) U.S. Cl. 707/101

(57) ABSTRACT

An apparatus and a method for presenting media content files which does not necessitate the creation of scripts and programs that are specific to the collection of media content files. The presentation is made self-organizing by establishing a set of rules governing the navigation of the collection of media content files stored in a structured file system. The media content files to be included in the presentation are given file names and are placed in directories in the file system in accordance with the set of rules. For presentation, the media content files are navigated in accordance with their files names, file content types, and directory placements by applying the set of rules and in response to navigation directives received from a user of a presentation system.

### FIELD OF INVENTION

The present invention relates to the field of multimedia content presentation. In particular, to an apparatus and a method for presenting media content files.

### BACKGROUND

In digital systems, media content is represented by the content of files within a file system. The file system typically provides a means of grouping and organizing the files in, for example, a hierarchical directory structure. A multimedia presentation of a collection of such media files can be arranged by establishing a sequence for presentation of the files or alternatively by permitting a user of a presentation system to navigate the content files by establishing a path or set of paths through the collection of media files. Paths can be established before the presentation begins or dynamically during the course of the presentation.

An exemplary application of such a multimedia presentation is a system providing media-enhanced self-guided tours of museums, galleries, exhibitions or other similar venues where the presentation of the content files is used to describe, augment, and complement the elements of a primary collection of artifacts.

Typically, scripts or programs that are specific to the collection of media content files must be created in order to control, sequence, and manage the presentation of the collect of media files. The scripts and programs that permit the user to navigate the content files generally being time consuming and labor intensive to produce. The scripts and programs are often subject to being revised when media content files are changed or added to an existing presentation. Typically, such scripts and programs cannot be altered during the course of the presentation.

What is needed is an apparatus and method for presenting media content files that does not necessitate the creation of scripts and programs that are specific to the collection of media content files.

### SUMMARY OF INVENTION

An apparatus and a method for presenting media content files which does not necessitate the creation of scripts and programs that are specific to the collection of media content files. The presentation is made self-organizing by establishing a set of rules governing the navigation of the collection of media content files stored in a structured file system. The media content files to be included in the presentation are given file names and are placed in directories in the file system in accordance with the set of rules. For presentation, the media content files are navigated in accordance with their files names, file content types, and directory placements by applying the set of rules and in response to navigation directives received from a user of a presentation system.

In accordance with one aspect of the present invention, a method of presenting a plurality of media content files, stored in a current directory selected from a hierarchical directory structure, to a user of a media presentation system, the method comprising the steps of: presenting the contents of the plurality of files, the files being presented in sequence according to a predetermined rule set; selecting as a new current directory a parent directory of the current directory when presentation of a last file of the plurality of files, according to the rule set, has terminated; and presenting a plurality of selections for a new current directory, each selection corresponding to one of a parent directory of the current directory and a child directory of the current directory, when the current directory contains no media content files.

In accordance with another aspect of the present invention, an apparatus for presenting a plurality of media content files, stored in a current directory selected from a hierarchical directory structure, to a user, the apparatus comprising: a user interface for presenting selections to and receiving inputs from the user; a directory navigator for identification of and navigation to files contained in the current directory and for identification of and navigation to other directories in the hierarchical directory structure; a media file presenter for presenting the contents of a file from the plurality of media content files; and a rule set manager, operatively connected to the user interface, the directory navigator and the media file presenter, providing for: presenting the contents of the plurality of files, the files being presented in sequence according to a predetermined rule set; selecting as a new current directory a parent directory of the current directory when presentation of a last file of the plurality of files, according to the rule set, has terminated; and presenting a plurality of selections for a new current directory, each selection corresponding to one of a parent directory of the current directory and a child directory of the current directory, when the current directory contains no media content files.

In accordance with still another aspect of the present invention, a computer program product for presenting media content files, stored in a current directory selected from a hierarchical directory structure, to a user of a media presentation system, the computer program product comprising: computer readable program code devices for: presenting the contents of the plurality of files, the files being presented in sequence according to a predetermined rule set; selecting as a new current directory a parent directory of the current directory when presentation of a last file of the plurality of files, according to the rule set, has terminated; and presenting a plurality of selections for a new current directory, each selection corresponding to one of a parent directory of the current directory and a child directory of the current directory, when the current directory contains no media content files.

Other aspects and features of the present invention will become apparent to those ordinarily skilled in the art to which it pertains upon review of the following description of specific embodiments of the invention in conjunction with the accompanying figures.

### BRIEF DESCRIPTION OF DRAWINGS

The present invention will be described in conjunction with the drawings in which:

FIG. 1 is a schematic representation of an exemplary embodiment of a presentation system according to the present invention.

FIG. 2 is schematic representation of an exemplary hierarchical directory structure having multiple directories each of which can contain other directories and media content files.

FIG. 3 is a flow diagram representing steps in the method for presenting media content files according to the present invention.

### DETAILED DESCRIPTION

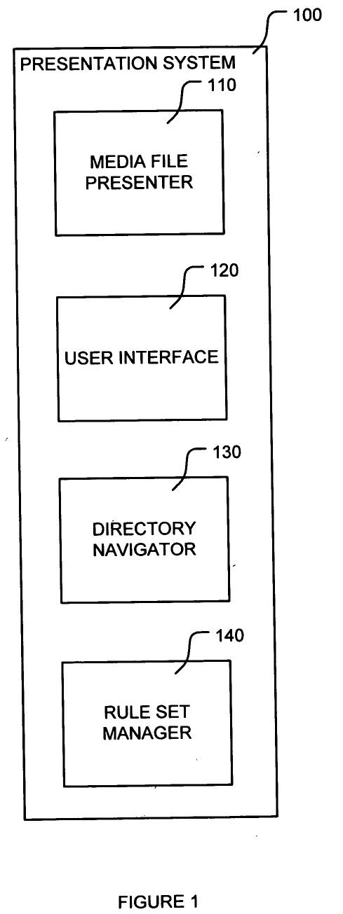

FIG. 1 is a schematic representation of an exemplary embodiment of a presentation system 100 according to the present invention. The presentation system 100 comprises a media file presenter 110, a user interface 120, a directory navigator 130, and a rule set manager 140. The media file presenter 110 provides for the presentation of a media content file in accordance with the file type such as, for example, text, hyper text markup language (HTML), Macromedia® Flash®, Joint Photographic Experts Group (JPEG), Moving Picture Experts Group (MPEG), MPEG layer 3 (MP3), MPEG-4 (MP4), and other similar media content file types. The user interface 120 provides for the presentation of the media content file by the media file presenter 110 to be directed to a user and for receiving inputs (directives) from the user. The user inputs can take the form of a selection from a set of choices presented to the user. The a directory navigator 130 provides for identification of and navigation to files contained in a current directory and identification of and navigation to other directories in a hierarchical directory structure including a parent directory and child directories of the current directory. The rule set manager 140 provides for the storage, administration, and application of a set of rules governing the presentation of the media content files in the current directory and navigation to other directories.

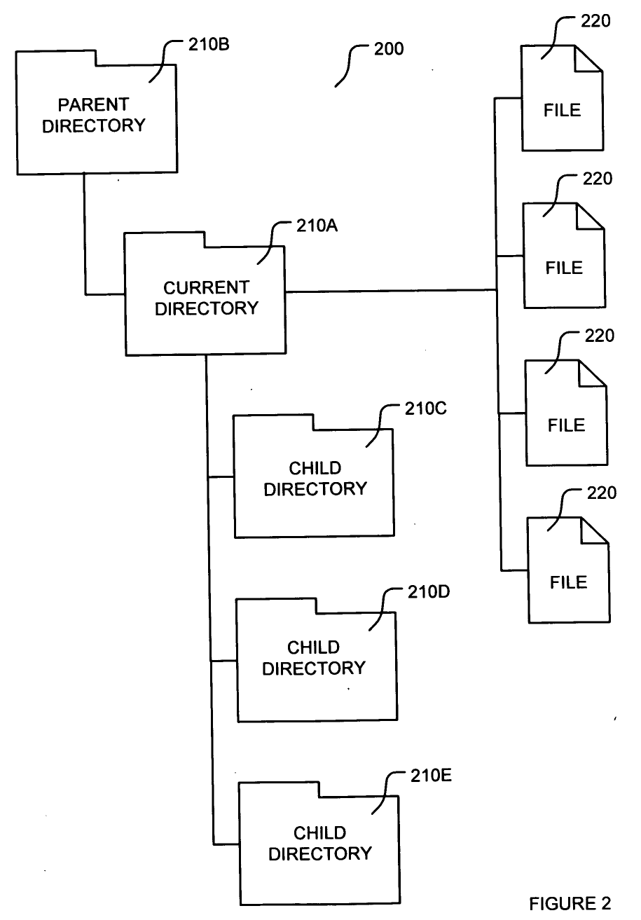

FIG. 2 is schematic representation of an exemplary hierarchical directory structure 200 having multiple directories 210A-E each of which can contain other directories and media content files 220. The hierarchical directory structure 200 will be used for the purpose of illustrating the operation of the present invention. One of the directories 210A-E is designated as the current directory 210A. The present invention is directed to presenting the media content files 220 contained therein. The current directory 210A can have a parent directory 210B and multiple child directories 210C-E.

The presentation system 100 can present the media content files 220 contained in the current directory 210A. The rule set manager 140 establishes an order of presentation for the media content files 220 in accordance with a set of rules stored in the rule set manager 140. The set of rules provides for files amongst the media content files 220 that have orderable filenames to be presented in sequence according to the order of their filenames. The orderable filenames can include, for example, an alphabetically sortable component, a numerically sortable component, a sortable file content type indicator (e.g. file extension ‘MP3’ followed by ‘JPG’ followed by ‘TXT’, etc.), and a combination thereof. The media file presenter 110 provides for the presentation of a file in accordance with the type of media contained in the file. The type of media contained in the file can be established using well known mechanisms such as filename extensions, file naming conventions, file content headers and other similar mechanisms.

Presentation of a file 220 can be terminated in response to an input received from the user by the user interface 120 indicating the user wishes to terminate presentation of the file or indicating that the user has selected a new current directory from the directories in the hierarchical directory structure 200.

Each file 220 to be presented can have an associated temporal duration (i.e. play time). Another rule in the set of rules provides for presentation of a file 220 to be terminated when the temporal duration of the file has expired (i.e. when all of the content has been presented.)

Yet another rule in the set of rules provides for selecting as a new current directory the parent directory 210B of the current directory 210A when presentation of all of the files 220 has been terminated.

A further rule in the set of rules provides for presenting the user with a set of selections for a new current directory, each selection corresponding to one of the parent directory 210B and the child directories 210C-E, when the current directory 210A contains no media content files 220.

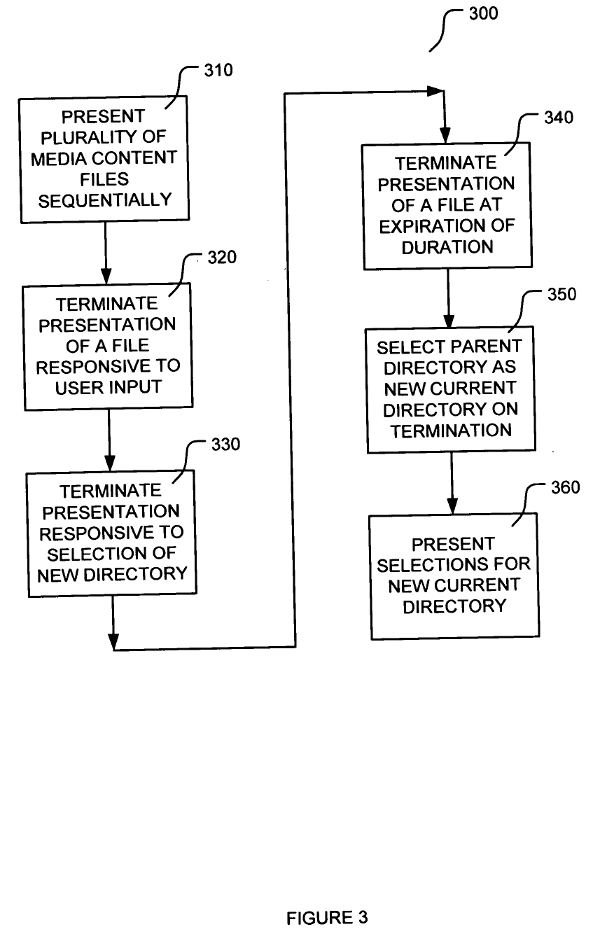

FIG. 3 is a flow diagram representing steps in the method 300 for presenting media content files 220 according to the present invention. The media content files 220 are contained in a current directory 210A which is part of a hierarchical directory structure 200 such as those represented in FIG. 2. The media content files 220 are presented to a user via a media presentation system that can comprise a presentation system 100 such as that represented in FIG. 1. In a step 310 of the method 300 the contents of a plurality of files amongst the media content files 220, each having a orderable filename, are presented. The files 220 are presented in sequence in accordance with a set of rules stored in the rule set manager 140. The sequence according to the set of rules can be based on the filenames, file content types and combinations thereof. Presentation of each file 220 in the plurality of files can be terminated 320 in response to an input from the user indicating a directive to terminate the presentation. Presentation of each file 220 in the plurality of files can also be terminated 330 in response to an input from the user indicating a selection of a new current directory from the hierarchical directory structure 200. Presentation of each file 220 in the plurality of files is terminated 340 when a finite temporal duration (i.e. play time) associated with the file has expired (i.e. all of the content of the file has been presented.) In step 350 the parent directory 210B of the current directory 210A is selected as a new current directory when presentation of all of the files 220 in the plurality of files have terminated. When the current directory 210A contains no media content files 220, the user is presented 360 with a plurality of selections for a new current directory, each selection corresponding to one of the parent directory 210B and the child directories 210C-E of the current directory 210A.

The method 300 according to the present invention can be implemented by a computer program product comprising computer executable program codes devices, for execution on a platform such as the presentation system 100 of FIG. 1 or other computing platforms, that implement the steps of the method 300.

It will be apparent to one skilled in the art that numerous modifications and departures from the specific embodiments described herein may be made without departing from the spirit and scope of the present invention.

1. A method of presenting a plurality of media content files, stored in a current directory selected from a hierarchical directory structure, to a user of a media presentation system, the method comprising the steps of:
presenting the contents of the plurality of files, the files being presented in sequence according to a predetermined rule set;
selecting as a new current directory a parent directory of the current directory when presentation of a last file of the plurality of files, according to the rule set, has terminated; and
presenting a plurality of selections for a new current directory, each selection corresponding to one of a parent directory of the current directory and a child directory of the current directory, when the current directory contains no media content files.

2. The method of claim 1, wherein each file of the plurality of files further having an orderable filename; and the sequence according to the rule set is based on the orderable filenames.

3. The method of claim 2, wherein each of the orderable filenames further comprising one of:
an alphabetically sortable component;
a numerically sortable component;
a sortable file content type indicator; and
a combination thereof.

4. The method of claim 1, wherein each file in the plurality of files further having a content type; and the step of presenting the contents is in accordance with the content type of each file.

5. The method of claim 1, further comprising the step of:
terminating the presentation of a file in the plurality of files responsive to an input provided by the user.

6. The method of claim 1, further comprising the step of:
terminating the presentation of a file in the plurality of files responsive to input provided by the user indicating the selection of a new current directory from the hierarchical directory structure.

7. The method of claim 1, further comprising the step of:
terminating the presentation of a file in the plurality of files having a finite temporal duration at the expiration of the temporal duration.

8. An apparatus for presenting a plurality of media content files, stored in a current directory selected from a hierarchical directory structure, to a user, the apparatus comprising:
a user interface for presenting selections to and receiving inputs from the user;
a directory navigator for identification of and navigation to files contained in the current directory and for identification of and navigation to other directories in the hierarchical directory structure;
a media file presenter for presenting the contents of a file from the plurality of media content files; and
a rule set manager, operatively connected to the user interface, the directory navigator and the media file presenter, providing for:
presenting the contents of the plurality of files, the files being presented in sequence according to a predetermined rule set;
selecting as a new current directory a parent directory of the current directory when presentation of a last file of the plurality of files, according to the rule set, has terminated; and
presenting a plurality of selections for a new current directory, each selection corresponding to one of a parent directory of the current directory and a child directory of the current directory, when the current directory contains no media content files.

9. The apparatus of claim 8, wherein each file of the plurality of files further having an orderable filename; and the sequence according to the rule set is based on the orderable filenames.

10. The apparatus of claim 9, wherein each of the orderable filenames further comprising one of:
an alphabetically sortable component;
a numerically sortable component;
a sortable file content type indicator; and
a combination thereof.

11. The apparatus of claim 8, wherein each file in the plurality of files further having a content type; and the media file presenter presenting the contents in accordance with the content type of the file.

12. The apparatus of claim 8, the rule set manager further providing for:
terminating the presentation of a file in the plurality of files responsive to an input provided by the user.

13. The apparatus of claim 8, the rule set manager further providing for:
terminating the presentation of a file in the plurality of files responsive to input provided by the user indicating the selection of a new current directory from the hierarchical directory structure.

14. The apparatus of claim 8, the rule set manager further providing for:
terminating the presentation of a file in the plurality of files having a finite temporal duration at the expiration of the temporal duration.

15. A computer program product for presenting media content files, stored in a current directory selected from a hierarchical directory structure, to a user of a media presentation system, the computer program product comprising:
computer readable program code devices for:
presenting the contents of the plurality of files, the files being presented in sequence according to a predetermined rule set;
selecting as a new current directory a parent directory of the current directory when presentation of a last file of the plurality of files, according to the rule set, has terminated; and
presenting a plurality of selections for a new current directory, each selection corresponding to one of a parent directory of the current directory and a child directory of the current directory, when the current directory contains no media content files.

16. The computer program product of claim 15, wherein each file of the plurality of files further having an orderable filename; and the sequence according to the rule set is based on the orderable filenames.

17. The computer program product of claim 16, wherein each of the orderable filenames further comprising one of:
an alphabetically sortable component;
a numerically sortable component;
a sortable file content type indicator; and
a combination thereof.

18. The computer program product of claim 15, wherein each file in the plurality of files further having a content type; and the computer readable program code device for presenting the contents presents in accordance with the content type of each file.

19. The computer program product of claim 15, further comprising computer readable program code devices for:
terminating the presentation of a file in the plurality of files responsive to an input provided by the user.

20. The computer program product of claim 15, further comprising computer readable program code devices for:
terminating the presentation of a file in the plurality of files responsive to input provided by the user indicating the selection of a new current directory from the hierarchical directory structure.

21. The computer program product of claim 15, further comprising computer readable program code devices for:
terminating the presentation of a file in the plurality of files having a finite temporal duration at the expiration of the temporal duration.
